(19) United States
(12) Patent Application Publication
(10) Pub. No.: US 2020/0249965 A1
(43) Pub. Date: Aug. 6, 2020

(54) Display Device with Built-In Web Browser for Graphical User Interface in an Embedded System

(71) Applicant: Renetec, Inc., Sunnyvale, CA (US)

(72) Inventor: Igor Shturma, Sunnyvale, CA (US)

(21) Appl. No.: 16/782,686

(22) Filed: Feb. 5, 2020

Related U.S. Application Data
(60) Provisional application No. 62/801,964, filed on Feb. 6, 2019.

(51) Int. Cl. G06F 9/451; G06F 13/42; G06F 3/0488; G06F 9/54; G06F 9/455

(52) U.S. Cl. CPC G06F 9/451; G06F 13/4282; G06F 9/45529; G06F 9/54; G06F 9/45512; G06F 3/0488

(57) ABSTRACT

A display device and a method for creating a GUI of embedded control systems in a display device are disclosed. In the display device, a web application containing executable scripts is loaded into a web browser, and an application programming interface (API) is provided by the web browser to the web application such that executable scripts within the web application can receive and transmit data over a serial interface of the display device. In the method, an API for executable scripts of the web application is provided such that the executable scripts can receive and transmit data over the serial interface of the display device.

### CROSS-REFERENCE TO RELATED APPLICATIONS

This application claims priority to U.S. Provisional Application No. 62/801,964 filed Feb. 6, 2019 by Igor Shturma entitled, “Display Device with Built-In Web-Browser Engine for Graphical User Interface in an Embedded System”, which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present disclosure relates to computer systems and, more specifically, to embedded systems that use a graphical display for a user to monitor and control the state of the system.

Every programmable microprocessor-based electronic control system with a dedicated function, e.g., not a general-purpose computing system, often integrated into a larger electrical, or electromechanical system can be called an embedded system. Examples of such systems are control systems for electric appliances, vending machines, information kiosks, factory control, entertainment systems, etc.

In the core of embedded systems, depending on the scale and functions, there is a general-purpose application processor, microcontroller, or a special purpose processor like a digital signal processor (DSP).

Many embedded systems require some kind of control panel to indicate the state of the system and let the user control its operation. This control panel may be as simple as a set of mechanical buttons and light emitting diode (LED) indicators or as complex as a touch-input capable display with an advanced multi-screen graphical user interface (GUI). There are multiple advantages of incorporating a graphical display into a control panel:
control is more intuitive to the user when it is accompanied by illustrations and on-screen help instructions;
buttons can be made multi-functional and context-dependent, which means less physical buttons are needed;
labels on control elements can be translated to different languages without the need for fixed market-specific labeling, which also allows an end consumer to select their language of preference themselves;
controls can be made with better esthetics which is a competitive advantage;
improvements can be introduced through software updates after the product is already manufactured;
some functions of the equipment can be offered as software options and don't require a control panel to be changed based on their selection;
reliability can be improved when mechanical controls such as switches, push buttons, and knobs are replaced with elements of GUI.

Despite of all of the advantages, the rate of adoption of graphical displays in stationary equipment is limited due to high cost of the components, the complexity and therefore cost involved in research and development work, etc. Even though the cost of hardware is continuously going down, GUIs incorporated into embedded systems are falling behind the interfaces of mobile and web applications in their aesthetic and ergonomic characteristics. Achievement of comparable quality is associated with serious technical challenges of building a rendering pipeline for complex geometry and fonts with shading and anti-aliasing. It calls for a high-bandwidth electrical interface between the processor and display panel to allow high frame rate, high color depth, and high pixel density.

Some solutions, for example in U.S. Pat. No. 7,027,056 B2, have been offered to partially offload computational complexity to a dedicated hardware closely coupled with display panel driving circuitry.

Other solutions, for example in U.S. Pat. No. 7,100,118 B1, incorporate a separate processor dedicated to rendering of the user interface based on a simplified version of Hypertext Markup Language (HTML) optimized for limited hardware resources has been suggested. This approach is still very limited in its capabilities compared to what is available to developers of modern web applications.

Web browsers are computer programs intended to retrieve, process, and display web pages containing textual, graphical, and video content. Web-pages include one or multiple inter-linked documents containing Hypertext Markup Language (HTML), Cascading Style Sheets (CSS), JavaScript, as well as additional resources. The look and behavior of the resulting page for a given set of source documents is consistent across different web browsers and defined by web standards mainly developed by World Wide Web Consortium (W3C). Elements of a web page as it is rendered to a screen are accessible to executable scripts by the means of the document object model (DOM). This makes the elements and their properties addressable within the script and available for manipulation. Web pages with executable scripts and dynamic content are commonly called web applications.

Development of web applications is a well-established process supported by widespread and continuously improving software tools and frameworks. In the current state of the art, creation of a high-quality modern web application is a routine task. On the contrary, development of a rich GUI for an embedded system is a complex problem that calls for highly-specialized software and specifically-trained engineering resources.

### SUMMARY

The display device is a computing system that contains a general-purpose application processor (CPU), a graphics processing unit (GPU), a volatile dynamic or static memory (RAM), a non-volatile memory, and peripheral interfaces, including digital inputs and outputs (e.g., a general purpose input and output (GPIO)) and serial interfaces such as but not limited to Universal Asynchronous Receiver/Transmitter (UART), Serial Peripheral Interface (SPI), Inter-IC (12C), Universal Serial Bus (USB). The display device also includes a graphical display with an optional touch input device. The display device may also include wired or wireless network interfaces such as Ethernet, Wi-Fi, and cellular.

The non-volatile memory stores processor-executable instructions of the operating system, device drivers, a web browser with a browser engine, and possibly some additional executable programs and program libraries. The memory also stores a web application made of one or multiple web pages that can be rendered and executed by the browser engine. It also stores all persistent data, e.g. application and system settings. The peripheral interfaces provide the means for the display device to be integrated with other components of a larger embedded system. The browser engine consists of a page layout engine, a rendering engine, and a scripting engine. Additionally, the browser includes, as part of the browser engine, or as a separate library, a component that provides application programming interface (API) for executable scripts to access the services of the operating system, including access to peripheral interfaces. The API contains functions and objects available to executable scripts of the web application to get access to hardware resources and interfaces, such as GPIO and serial interfaces, as well as the components of the operating system itself. This lets scripts simultaneously interact with visual elements of a web page and with other components of an embedded control system by means of hardware interfaces. At the same time, a communication path is provided from a serial interface to the scripting engine that allows other components of an embedded system to execute functions and access object properties within the script execution context of the web application. The objects can include DOM elements of a web page.

In some embodiments, the browser does not include a multi-tab or multi-window interface, address bar, context menus, bookmarks, browsing history, or support for non-pre-installed extensions. The operating system is also optimized for the purpose of only running necessary kernel processes, device drivers, and the browser application.

When the device is first powered-up, executable instructions of the operating system with device drivers, web browser, page layout engine, rendering engine, scripting engine, and networking libraries are loaded from the non-volatile memory to RAM for execution by CPU. Then, the first web page of the web application together with any referred additional documents and resources are loaded to RAM. The layout engine produces the layout of the page as it will be rendered to the screen according to the specifications of a markup language used to represent GUI elements. The rendering engine then creates, using the GPU, a rasterized image in a frame buffer in RAM, ready to be shown on a display. A video interface controller transfers the content of the frame buffer over the display interface to the display driver. The display driver generates electrical signals that make the graphical display show the rendered image of the web page.

In some embodiments of the display device, an executable script of the web application calls an API function to determine the state of an input line and changes at least one visual characteristic of at least one GUI element based on this state.

In some embodiments of the display device, an executable script of the web application calls an API function to receive data over a serial interface and changes at least one visual characteristic of at least one GUI element based on this data.

In some embodiments of the display device, a function of executable script is called as a result of a user touching a screen region occupied by a GUI element, and within the function an API function is called to set the state of at least one output line.

In some embodiments of the display device, a function of executable script is called as a result of a user touching a screen region occupied by a GUI element, and within the function an API function is called to send data over a serial interface.

In some embodiments of the display device, data received over a serial interface triggers an execution of a sequence of script instructions in the web application.

In some embodiments of the display device, change of state of an input line triggers an execution of a sequence of script instructions in the web application.

In some embodiments of the display device, data received over a serial interface contains an instruction that is executed by the scripting engine in the context of the web application. Wherein such instruction maybe a plain American Standard Code for Information Interchange (ASCII) text or an encoded byte sequence.

In some embodiments of the display device, data received over a serial interface contains an identifier (address) of a property defining some visual characteristic of a GUI element, and a new value for said property. Wherein the identifier and the value may be a plain ASCII text or an encoded byte sequence.

In some embodiments of the display device, an executable script of the web application calls an API function to execute one or more commands of the operating system.

Therefore, the communication path is provided for the processor within the embedded system to interact with elements of the web application. At the same time, the web application can interact with other components of the embedded control system directly. This gives great flexibility in making decisions regarding the architecture of the control system based on the business needs. Multiple options are possible. (1) The display device is the main actor with the application business logic coded within the web application, and the role of another processor is reduced to the control of sensing and actuation, or the processor is eliminated completely. (2) The display device is used as a GUI only and completely controlled from another processor. (3) Some combination of the two with responsibilities arbitrarily distributed between the web application and application within another processor.

In alternative embodiments of the present disclosure, the display device contains network interface circuitry, the operating system contains networking drivers and libraries, and the web browser contains libraries for supporting network protocols. In this embodiment, at least one element of the web application is loaded from a remote server.

In some embodiments the display device contains audio circuitry and is capable of reproducing audio resources from the web application.

In some embodiments of the present disclosure, the snapshot of RAM memory with preloaded web application is stored in the non-volatile memory and restored after power-up.

In some embodiments the display device is manufactured as a standalone unit or module and connected to an embedded system by input and output lines and serial interfaces. In some alternative embodiments, parts of the display device are placed on the same printed circuit board (PCB) as other components of an embedded control system.

The use of a serial interface benefits the interoperability of the display device. It allows the integration with other components of an embedded system in a standard way, universally supported by active digital electronic components, such as microcontrollers, application processors, signal converters, smart sensors, etc. Therefore, the web application developer can write executable scripts that directly provide data to those components based on user input, and update user output based on the data received from those components. With another processor in an embedded control system, a simple protocol can be designed to exchange data over a serial interface between the web application and the application executed by another processor. The protocol is implemented from both sides and creates a natural boundary of responsibilities in the development workflow.

The browser being built-in into the display device allows the display device to present a sophisticated graphical user interface while keeping the electrical interfaces with the rest of the control system very simple and feasible with only inexpensive components.

As the operating system and the browser are optimized for a single purpose of only presenting a limited application-specific set of web pages, this allows better performance to be achieved with lower computing power of the CPU and GPU, and ultimately reduce the cost of the hardware needed. It also reduces loading time at system power-up and energy consumption compared to a general purpose computing system.

Extending the browser with the libraries for input and output access to the hardware eliminates the need for a local back-end server and stack of network protocols between the web application and the server. This is beneficial for more efficient use of computing hardware, as well as for reduction of software development effort.

As a result of the present disclosure, the display device allows the GUI of an embedded control system to be developed as a web front-end application using an appropriate stack of technologies. By building the bridge between the executable part of the web application and the underlying hardware, the present disclosure greatly extends the capabilities of the web browser and makes it possible to build web applications that control physical equipment. This approach has the following benefits:
allows prototyping and testing of the interface using widely available software tools with minimum training required; and
allows the use of a general purpose workstation or mobile device for testing and development on all intermediate stages without the need for the target hardware until the very last moment.

Ultimately, for original equipment manufacturers (OEMs), this reduces development time and effort, lowering associated costs and products time to market.

Use of the display device as a unit within a larger system has architectural benefits. Isolation of GUI-related hardware from other components of an embedded control system helps avoid interference between critical real-time control tasks and high latency user interface code that unavoidably arises when the two are executed within the same processor. The device is easy to integrate into existing systems as a replacement for a traditional control panel with mechanical knobs and buttons. As it complements an existing processor, minimum modifications are needed to the existing control software. In some simple systems it is possible to implement the whole control logic within the web application eliminating the need for a second processor.

### BRIEF DESCRIPTION OF THE DRAWINGS

FIG. 1 is a schematic block diagram showing the hardware components of the display device.

FIG. 2 is a schematic block diagram showing the software components stored within the non-volatile memory of the display device.

FIG. 3 illustrates a side view of a baking oven control as an example of a GUI.

FIG. 4 illustrates a schematic diagram of the display device within an embedded control system.

### DETAILED DESCRIPTION

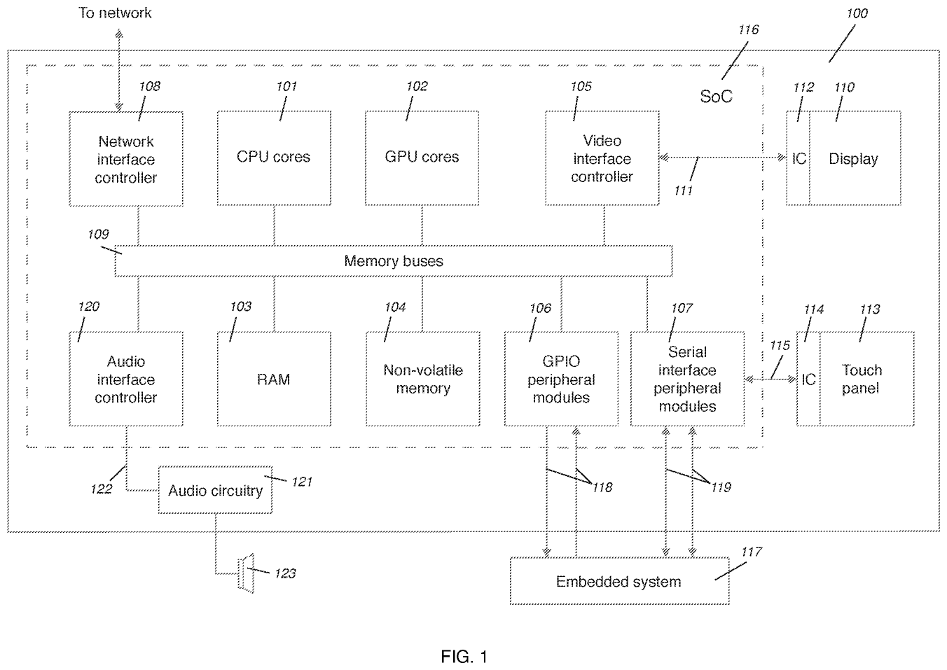

FIG. 1 is a schematic block diagram showing the hardware components of the display device 100 which is a computing system including one or multiple central processing unit (CPU) cores 101, graphical processing unit (GPU) cores 102, a volatile dynamic or static memory (RAM) 103, a non-volatile memory 104, video interface controller 105, general-purpose input and output (GPIO) peripheral modules 106, serial interface peripheral modules 107, and optional network interface controller 108, interconnected through memory buses 109. Some or all of the above-mentioned components can be contained within a single-package system on a chip (SoC) 116. Video interface controller 105 is connected to the display driver IC 112 of the graphical display 110 with the display interface 111. The device can include touch input panel 113 with a touch panel driver IC 114 connected over a serial interface 115. GPIO lines 118 and serial interfaces 119 connect the display device 100 to an embedded control system 117. Serial interfaces 119 include but are not limited to UART, SPI, 12C, USB, Controller Area Network bus (CANBus). The display interface 111 may be a parallel Red Green Blue (RGB) interface, Low-voltage Differential Signaling (LVDS), Display Serial Port (DSI), High-Definition Multimedia Interface (HDMI), embedded DisplayPort (eDP), or some other. The non-volatile memory 104 may be of any technology such as fixed embedded Multi-Media Controller (eMMC) or removable Secure Digital (SD) card flash memory.

SoC 116 can also include audio interface controller 120 and the display device 100 can include audio circuitry 121 connected to the audio interface controller 120 over an audio interface 122 such as but not limited to analog audio interface or digital Inter-IC Sound (I2S) interface. A speaker 123 can be connected to the audio circuitry 121.

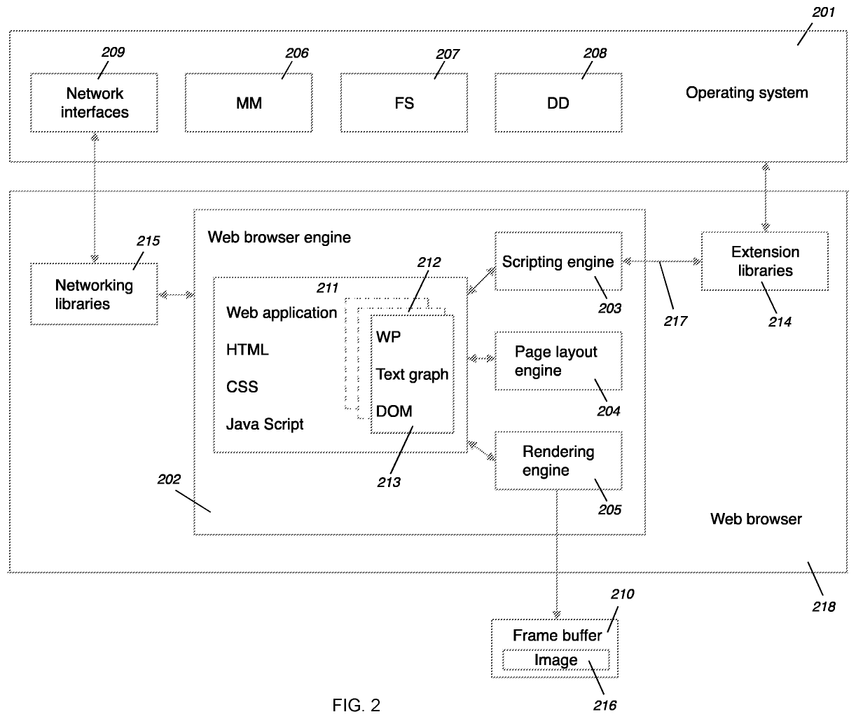

FIG. 2 is a schematic block diagram showing the software components stored within the non-volatile memory 104 of the display device 100. Operating system (OS) 201 comprises various system components such as memory management 206, file system 207, device drivers 208, and network interfaces 209. The OS 201 provides an execution environment for the web browser 218 with the web browser engine 202 comprising of the page layout engine 204, the rendering engine 205, and the scripting engine 203. The web browser 218 is extended with the libraries 214 providing an API 217 access to components of the OS 201. The web browser 218 may also include networking libraries 215. The web application 211 is a collection of the web pages 212 with their resources such as text, images, animation, and executable scripts. Every page contains a hierarchy of addressable objects and their properties known as document object model (DOM) 213.

First, executable instructions of the operating system 201 with the web browser 218 are loaded from non-volatile memory 104 to RAM 103 for execution by CPU cores 101. Then the first web page of web pages 212 is loaded to RAM 103 from either a local non-volatile memory 104 through the file system 207 or from a remote network location through the networking libraries 215 and network interfaces 209. The page layout engine 204 produces the layout of the first web page 212 as it will be rendered to the screen according to the specifications of markup language defining the elements of the GUI. Then, the rendering engine 205 creates a rasterized image 216 that is stored in the frame buffer 210 ready to be shown on the graphical display 110. The rendering engine 205 is using the GPU cores 102 to achieve high rendering performance.

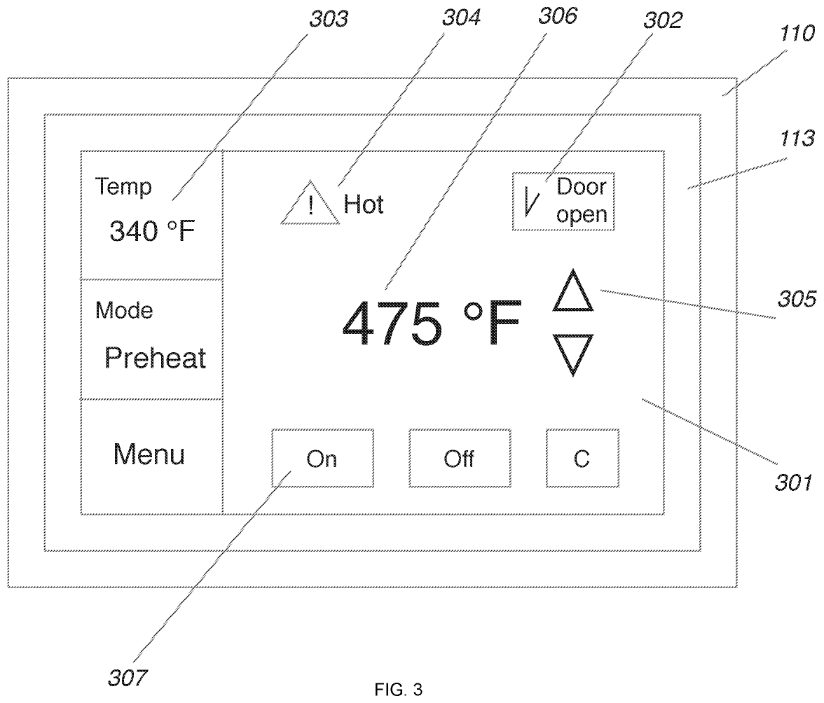

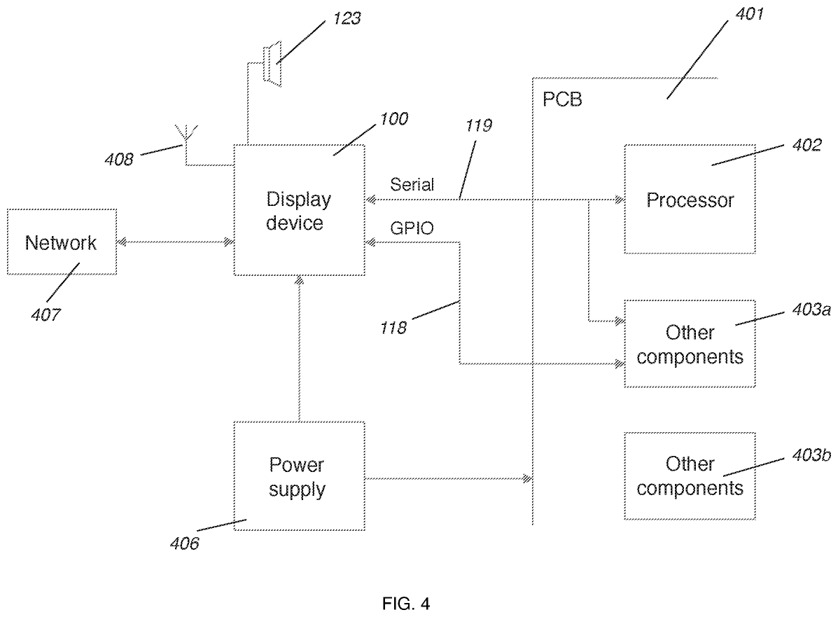

FIG. 3 illustrates a side view of a baking oven control as an example of a GUI, and is described with reference to components in FIG. 4. In FIG. 3, graphical display 110 with a touch input panel 113 is showing a rendered web page 301.

A script from the web application 211 executed by the script engine 203 uses the application programming interface (API) 217 provided by the extension libraries 214 to obtain the state of at least one of the GPIO lines 118 (e.g., an input) and accesses the visual element 302 of the GUI through DOM 213 to change the color of the visual element 302 between grey and yellow to indicate the state. The script reads data over one of the serial interfaces 119 and uses that data to update the text of the element 303 to show an actual temperature, and the color of the element 304 when the temperature exceeds a particular value. In response to user interaction with the button 305, a script function is executed that increases the value of desired temperature 306 and uses a serial interface 119 to transmit a new value to the processor 402 responsible for temperature control. In response to user interaction with the button 307 a script function is executed that uses GPIO module 106 (a.k.a., peripheral) to assert a GPIO line 118 (e.g., an output) controlling the oven light.

In an alternative aspect, a script function is triggered into execution after data is received form the processor 402 over the serial interface 119. That instruction contains a request to retrieve the status of the button 305 and if the button is pressed, the processor 402 transmits another instruction to update the text of the temperature 306 to a new value.

FIG. 4 illustrates a schematic diagram of the display device 100 within an embedded control system. The main processor 402 of the control system is placed on the printed circuit board (PCB) 401 with other components 403a and 403b. The display device 100 is connected to the main processor 402 and to the other components 403a by the means of serial interface 119 and GPIO lines 118. The display device 100 and the rest of the control system are connected to the power supply 406. The display device 100 is connected to the wired network 407 and to the wireless network (e.g. Wi-Fi or cellular) with the antenna 408. The display device 100 is connected to the speaker 123.

While several embodiments and aspects have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A display device for graphical user interface (GUI) in an embedded system comprising:
a central processing unit (CPU) executing an operating system and a web browser;
a graphics processing unit (GPU) rendering the GUI;
a volatile memory (RAM), storing executable code and operating data including the rendered GUI,
a non-volatile memory, storing executable code and persistent data;
a graphical display showing the GUI to a user; and
a serial interface used for integration of the display device with the embedded system;
wherein a web application containing executable scripts is loaded into the web browser, and an application programming interface (API) is provided by the web browser to the web application such that the executable scripts within the web application can receive and transmit data over the serial interface.

2. The display device according to claim 1, wherein the graphical display has a touch input device attached to it.

3. The display device according to claim 1, additionally comprising circuitry configured to drive an audio speaker.

4. The display device according to claim 1, additionally comprising general purpose input and output (GPIO) lines for integration with the embedded system.

5. The display device according to claim 4, wherein additionally the API is provided by the web browser to the web application such that the executable scripts within the web application can check and assert a state of the GPIO lines.

6. The display device according to claim 1, additionally comprising a wired network interface or a wireless network interface.

7. The display device according to claim 1, wherein additionally the API is provided by the web browser to the web application such that the executable scripts within the web application can execute commands of the operating system.

8. The display device according to claim 1 wherein the serial interface is a Universal Asynchronous Receiver/Transmitter (UART) interface.

9. The display device according to claim 1 wherein the serial interface is a Serial Peripheral Interface (SPI).

10. A method for creating a graphical user interface (GUI) of an embedded system in a display device with a serial interface and built-in web browser comprising:
loading executable code of an operating system, and a web browser from a non-volatile memory into a volatile memory for execution by a processor;
loading a web application into the web browser; and
providing an application programming interface (API) for executable scripts of the web application such that the executable scripts can receive and transmit data over the serial interface.

11. The method according to the claim 10, further comprising calling an API function from within at least one of the executable scripts of the web application to receive data over the serial interface and changing at least one visual characteristic of at least one GUI element within the web application.

12. The method according to the claim 10, further comprising calling an API function from within at least one of the executable scripts of the web application to send data over the serial interface in response to a user touching a screen region occupied by a GUI element.

13. The method according to the claim 10, further comprising receiving an instruction over the serial interface and executing the instruction within the web application.

14. The method according to the claim 10, further comprising receiving an identifier of an addressable property of a GUI element, receiving a new value for the addressable property, and updating the addressable property with the new value.

15. The method according to the claim 10, further comprising calling a function of at least one of the executable scripts within the web application in response to a data transmission over the serial interface.

16. The method according to the claim 10, wherein the display device contains general-purpose input and output (GPIO) lines, the method further comprising providing the API for the executable scripts of the web application such that the executable scripts can check and assert a state of the GPIO lines.

17. The method according to the claim 10, further comprising calling an API function from within at least one of the executable scripts of the web application to determine a state of an input line and changing at least one visual characteristic of at least one GUI element within the web application.

18. The method according to the claim 10, further comprising calling an API function from within at least one of the executable scripts of the web application to assert a state of an output line in response to a user touching a screen region occupied by a GUI element.

19. The method according to the claim 10, further comprising calling a function of at least one of the executable scripts within the web application in response to a change in a state of an input line.

20. The method according to the claim 10, wherein the API for the executable scripts of the web application is provided such that the executable scripts can execute commands of the operating system.
